(19) United States
(12) Patent Application Publication
(10) Pub. No.: US 2014/0019560 A1
(43) Pub. Date: Jan. 16, 2014

(54) PERFORMANCE STRESS EVALUATION OF MULTI-MODAL NETWORK NOTIFICATION SERVICE

(71) Applicants: Juan Jenny Li, Basking Ridge, NJ (US); Colin L. Mallows, Flemington, NJ (US); James M. Landwehr, Summit, NJ (US)

(72) Inventors: Juan Jenny Li, Basking Ridge, NJ (US); Colin L. Mallows, Flemington, NJ (US); James M. Landwehr, Summit, NJ (US)

(73) Assignee: AVAYA INC., Basking Ridge, NJ (US)

(21) Appl. No.: 13/645,823

(22) Filed: Oct. 5, 2012

Related U.S. Application Data
(60) Provisional application No. 61/671,560, filed on Jul. 13, 2012.

(51) Int. Cl. G06F 15/173

(52) U.S. Cl. 709/206; 709/224

(57) ABSTRACT

Embodiments disclosed herein provide systems and methods for evaluating performance stress in a multi-modal network notification service. In a particular embodiment, a method provides generating a covering array of test factors corresponding to a plurality of modes and a plurality of test level values for each mode and determining an escalation hierarchy of the covering array comprising a plurality of nodes, wherein each node corresponds to a set of test factors in the covering array. The method further provides performing a notification test run of the set of test factors for each node in the escalation hierarchy to determine performance stress for each set of test factors. The method further provides generating a first factor-level-run table with the notification test runs corresponding to each of n-wise test factors and possible test level values and indicating which of the notification test runs in the factor-level-run table resulted in performance stress.

### RELATED APPLICATIONS

This application claims the benefit of U.S. Provisional Application No. 61/671,560, filed Jul. 13, 2012, which is hereby incorporated by reference in its entirety.

### TECHNICAL BACKGROUND

A notification service alerts a large number of recipients to attend to important or emergency events. Recent natural disasters have shown that quick timing and sufficient range of notification can help to reduce damage and even save lives. To insure timely alert delivery, a notification service needs to provide multi-modal messages to subscribers based on their real-time on-line status. Traditionally, a notification system alerts subscribers by phone calls or emails. With the increased usage of multi-modal media, notification channels can now include voice calls, videos, IM server, social network sites, SMS, mobile devices, and the like.

Traditionally, the notification load increases only in one dimension either phone message broadcasting or mass aliases emailing. For example, conventional telephone notification systems only need to deal with the number of phone calls that the system can notify within a certain timeframe. As we move towards multi-modal heterogeneous systems, the notification loads have many dimensions, ranging from short text messaging to complex video conferencing. The number of notification dimensions increases along with the increase of the system's flexibility, complexity, and notification modes.

### Overview

Embodiments disclosed herein provide systems and methods for evaluating performance stress in a multi-modal network notification service. In a particular embodiment, a method provides generating a covering array of test factors corresponding to a plurality of modes and a plurality of test level values for each mode and determining an escalation hierarchy of the covering array comprising a plurality of nodes, wherein each node corresponds to a set of test factors in the covering array. The method further provides performing a notification test run of the set of test factors for each node in the escalation hierarchy to determine performance stress for each set of test factors. The method further provides generating a first factor-level-run table with the notification test runs corresponding to each of n-wise test factors and possible test level values and indicating which of the notification test runs in the factor-level-run table resulted in performance stress.

### BRIEF DESCRIPTION OF THE DRAWINGS

FIG. 1 illustrates a communication system for evaluating performance stress in a multi-modal network notification service.

FIG. 2 illustrates the operation of the wireless communication system for evaluating performance stress in a multi-modal network notification service.

FIG. 3 illustrates a combinatory system for evaluating performance stress in a multi-modal network notification service.

FIG. 4 illustrates a covering array for evaluating performance stress in a multi-modal network notification service.

FIG. 5 illustrates an escalation hierarchy for evaluating performance stress in a multi-modal network notification service.

FIG. 6 illustrates a combinatory system for evaluating performance stress in a multi-modal network notification service.

FIG. 7 illustrates a covering array for evaluating performance stress in a multi-modal network notification service.

FIG. 8 illustrates an escalation hierarchy for evaluating performance stress in a multi-modal network notification service.

FIG. 9 illustrates an algorithm for evaluating performance stress in a multi-modal network notification service.

FIG. 10 illustrates an escalation hierarchy for evaluating performance stress in a multi-modal network notification service.

FIG. 11 illustrates an escalation hierarchy for evaluating performance stress in a multi-modal network notification service.

FIG. 12 illustrates a factor-level-run table for evaluating performance stress in a multi-modal network notification service.

FIG. 13 illustrates a factor-level-run table for evaluating performance stress in a multi-modal network notification service.

FIG. 14 illustrates a factor-level-run table for evaluating performance stress in a multi-modal network notification service.

FIG. 15 illustrates a notification test system for evaluating performance stress in a multi-modal network notification service.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

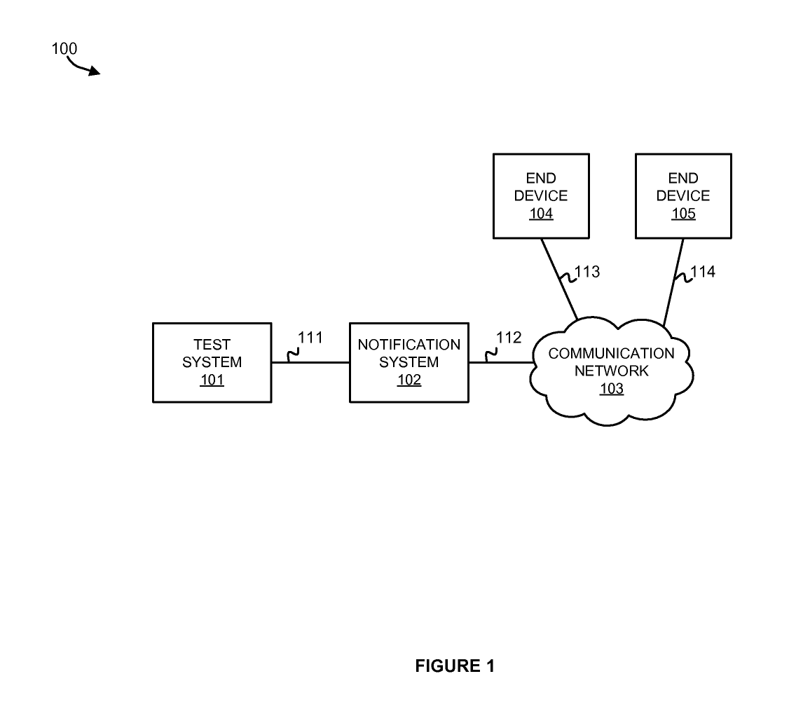

FIG. 1 illustrates communication system 100. Communication system 100 includes notification test system 101, notification system 102, communication network 103, and end devices 104 and 105. Notification test system 101 and notification system 102 communicate over communication link 111. Notification system 102 and communication network 103 communicate over communication link 112. Communication network 103 and end devices 104-105 communicate over communication links 113-114, respectively.

In operation, notification system 102 is a system configured to transfer notifications over a plurality of different communication modes, such as phone, video conferencing, instant messaging, email, text messages, or any other communication format. The notifications are transferred to end devices, such as end devices 104 and 105, over communication network 103. The type of notification received by end devices 104 and 105 will depend on the capabilities of each end device. For example, if end device 104 is a traditional phone, then the notification sent to end device 104 will be in the form of an audio based phone call. In the alternative, if end device 105 is a tablet computer, then end device 105 may receive the notification in email or instant messaging format. If a particular end device is capable of receiving more than one type of notification, then the notifications received by that device may further depend on a preference or default notification type(s) for that device.

Test system 101 is configured to generate test notification runs for notification system 102 and provide analysis of the results for the test runs. Since notification system 102 is capable of providing notifications of varying types, it may be important to determine which combinations of notification loads cause performance issues in notification system 102. For example, notification system 102 may be able to handle high notification loads in both email and audio call but performance issues occur when the notification loads in email and video call notifications are both high.

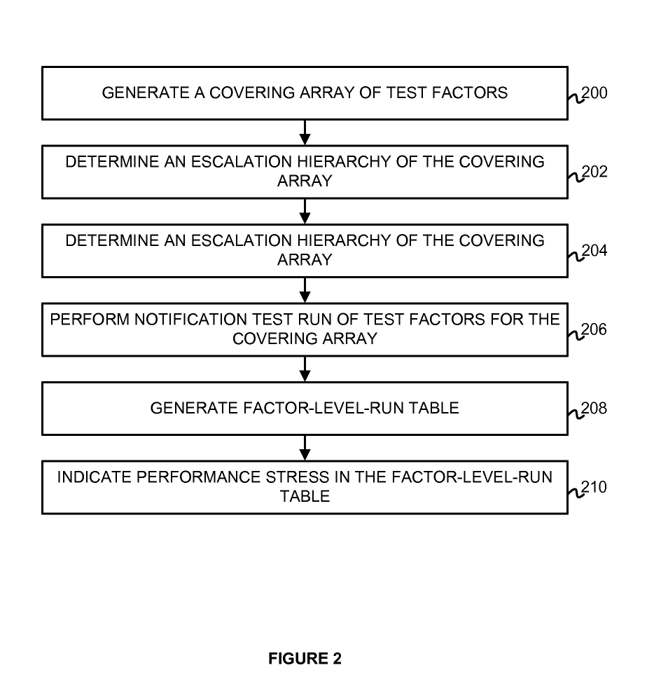

FIG. 2 illustrates the operation of wireless communication system 100 to evaluate performance stress in a multi-modal network notification service. Test system 101 generates a covering array of test factors corresponding to a plurality of modes and a plurality of test level values for each mode (step 200). The mode and level parameters may be entered by a user, determined by test system 101 itself, received over a network, or any other method of indicating parameters. The plurality of modes may include audio phone, such as POTS or VoIP, video conferencing, instant messaging, email, and text messaging, such as short message service (SMS), or any other communication format—including combinations thereof. The test levels comprise two or more levels of communication loads for each mode. For example, each mode may have a low, medium, and high level. Additionally, the number of notifications that constitute each level may be different for each mode. Thus, the number of notifications considered high for one mode may be much higher than the number of notifications considered high for another node.

The covering array is an array generated that includes possible test combinations (test factors) of the plurality of levels for the plurality of communication modes. The covering array may have varying strengths from pair-wise, which includes all possible level combinations between each pair within the communication modes, up to all possible level combinations between all modes. For example, a pair-wise covering array will list possible combinations of the levels for all modes so that all possible level combinations occur for each pair of modes. Likewise, a three wise covering array will list possible combination of the levels for all modes so that all possible level combinations occur for each combination of three modes.

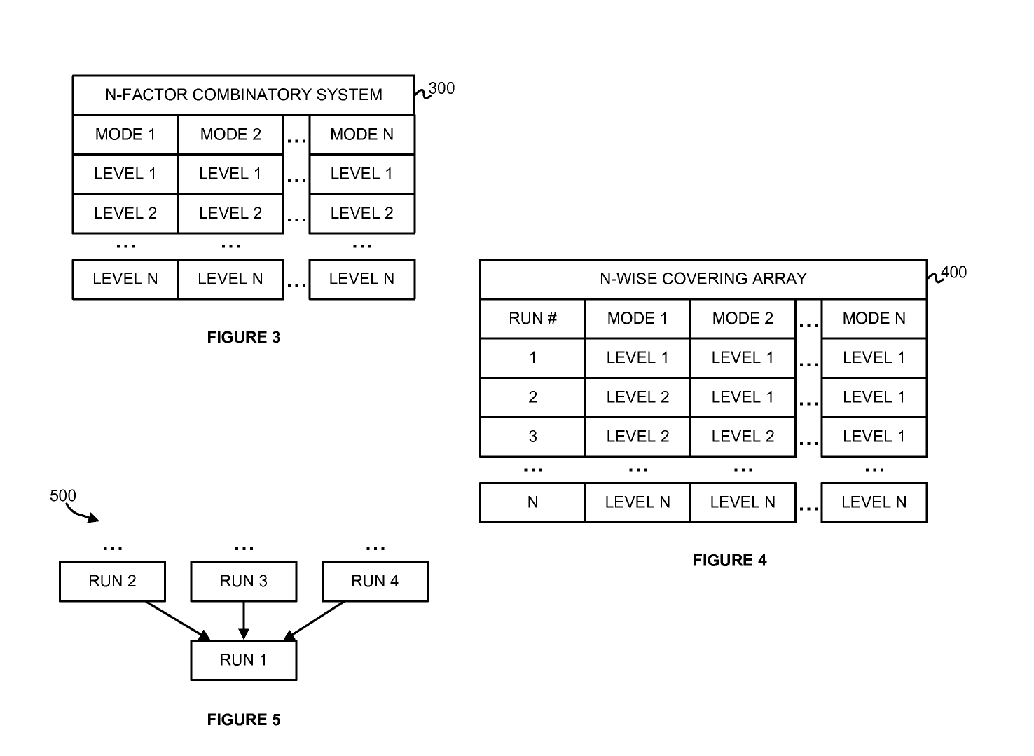

FIG. 3 illustrates an exemplary N-factor combinatory system table 300. Table 300 may be displayed on a display system of test system 101 for the benefit of a test system operator or table 300 may represent a data structure stored in a storage system of test system 101. Table 300 illustrates a plurality of notification modes 1−N with each notification mode having 1−N levels. For example, mode 1 may be voice call notifications and level 1 for the voice call notifications may be 1,000 notifications, level 2 may be 10,000 notifications, and the notification levels increase up to level N. Similarly, node 2 may be text message notifications and level 1 for the text message notifications may be 5,000 notifications, level 2 may be 20,000 notifications, and the notification levels increase up to level N.

FIG. 4 illustrates an exemplary N-wise covering array 400 of the factors presented in table 300. Covering array 400 may be displayed on a display system of test system 101 for the benefit of a test system operator or array 400 may represent a data structure stored in a storage system of test system 101. Covering array 400 provides mode and level combinations that may be used in notification test runs 1−N. Covering array 400 may include runs for all possible mode and level combinations or may include runs for all mode combinations between all groups of two or more modes.

Referring back to FIG. 2, after generating the covering array, test system 101 determines an escalation hierarchy of the covering array comprising a plurality of nodes, wherein each node corresponds to a set of test factors in the covering array (step 202). The escalation hierarchy allows provides a structure for performance escalation between sets of test factors in the covering array. The root node of the escalation hierarchy should correspond to the test factors in the covering array that indicate all modes at their lowest level. Then the nodes branching from the root include test factor sets where the level is increased for at least one mode and no levels are decreased from the levels of the root.

Accordingly, if the root represents the lowest test level of all the test factor sets in the covering array, all other factor sets in the covering array may branch directly from the root node. However, it is advantageous to generate more levels of the escalation hierarchy in order for more test results to be used for data consistency. For example, a data consistency with a node with a mode increasing by 3 levels from the root is harder to check for consistency because an inconsistent test result may have stemmed from the first level increase or the second. Therefore, it would be beneficial for the child nodes branching from the root to increase by the fewest levels possible for any give mode, ideally only one level, and then generate further escalation levels from those child nodes in a similar manner.

FIG. 5 illustrates an exemplary escalation hierarchy 500 of covering array 400. Escalation hierarchy 500 may be displayed on a display system of test system 101 for the benefit of a test system operator or escalation hierarchy 500 may represent a data structure stored in a storage system of test system 101. Run 1 from covering array 400 is the root node because run 1 represents a test run where all modes 1−N are at level 1. Since all modes in run 1 are at the lowest test notification level, any node branching upwards from run 1 will be a performance escalation of run 1. Runs 2-4 are shown as child nodes of run 1 but other nodes may be direct children of run 1 as well. Moreover, further nodes may branch from the child nodes to create further performance escalation levels of the escalation hierarchy in a manner similar to that shown for the root.

In some embodiments, multiple escalation hierarchies may be generated based on the procedure defined above. Test system 101 may then select an escalation hierarchy from these hierarchies based on a degree of escalation for each escalation hierarchy. The degree of escalation for an individual escalation hierarchy is defined as a percentage of the highest possible escalation for an escalation hierarchy of the covering array. The escalation for a given escalation hierarchy is the number of vertices in the hierarchy and the highest possible escalation can be expressed as n(n−1)/2 where n is the number of vertices in the escalation hierarchy. The degrees of escalation for each escalation hierarchy can then be compared to select escalation hierarchies that are more likely to reveal data inconsistency issues discussed further below.

After generating the escalation hierarchy, test system 101 performs a notification test run of the set of test factors for each node in the escalation hierarchy to determine performance stress for each set of test factors (step 204). To perform the notification test runs, test system 101 may instruct notification system 102 to generate test notifications in accordance with each set of test factors and then monitors the progress of notification system 102 to generate test data for each of the test runs. The test data may include time information regarding the amount of time each test set took to complete as a whole or by individual factors in a given test set. The test data may further include error information received from notification system 102 or any other information that may be useful to test system 101 when analyzing the test data.

In some embodiments, the escalation hierarchy may be used by test system 101 to determine whether a test run is inconsistent. Specifically, the performance escalation aspect of the escalation hierarchy means that the amount of time needed to perform a test run on test factors of a child node (response time) should not be shorter than the amount of time to perform a test run on test factors of the parent node for any mode in the test set. This conclusion can be drawn because, since each mode of a child node has a test level greater than or equal to the test level of the parent, the amount of notifications for a mode in the child is greater than or equal to the amount of notifications for that mode in the parent. More notifications should take longer process and transmit in notification system 102, thereby, using more time. Accordingly, if test data indicates that a response time of a mode in the child node is less than that for the same mode in the parent node, then that indication is most likely caused by errors in the test data and further analysis of that test data would be inconsistent for further analysis.

Test system 101 further generates a factor-level-run table with the notification test runs corresponding to each of n-wise test factors and possible test level values (step 208). The factor-level-run table may be displayed on a display system of test system 101 for the benefit of a test system operator or the factor-level-run table may represent a data structure stored in a storage system of test system 101. The factor-level-run table includes rows of mode combinations and the columns represent their possible values. The mode combinations should comprise at least 2 modes per combination up to the total number of modes in a single combination. The columns then represent the possible combination of the modes. The resulting cells display the test runs with test factors from the escalation hierarchy that satisfies the corresponding mode and level.

After generating the factor-level-run table, test system 101 indicates which of the notification test runs in the factor-level-run table resulted in performance stress (step 210). If the factor-level-run table is displayed, then the indication may be displayed in a visual manner to an operator of the test system, such as by highlighting cells in the factor-level-run table that resulted in performance stress, placing an icon in the cell, or any other way of visually indicating cells having performance stress. Alternatively, if the factor-level-run table is stored in test system 101, then the indication is stored in association with the factor-level-run table. Performance stress may be due to an overload in the notification capacity of notification system 102 or any other reason that the performance of notification system 102 may suffer.

Once the factor-level-run table indicates test runs that resulted in performance stress, the factor-level-run table may be analyzed to determine which notification combination cause the performance stress. An operator of test system 101 may perform the analysis, test system 101 may execute an algorithm to perform the analysis, or some other analysis system may be employed to analyze the factor-level-run table.

Referring back to FIG. 1, notification test system 101 comprises a computer system and communication interface configured to operate as described above. Notification test system 101 may also include other components such a router, server, data storage system, and power supply. Notification test system 101 may reside in a single device or may be distributed across multiple devices. Notification test system 101 is shown externally to notification system 102, but the functionality of notification test system 101 could be integrated within the components of notification system 102.

Notification system 102 comprises a computer system and communication interface configured to operate as described above. Notification system 102 may also include other components such a router, server, data storage system, and power supply. Notification system 102 may reside in a single device or may be distributed across multiple devices.

Communication network 103 comprises network elements that provide communications services to notification system 102 and end devices 104-105. Additionally, notification test system 101 may communicate with notification system 102 over communication network 103. Communication network 103 may comprise switches, wireless access nodes, Internet routers, network gateways, application servers, computer systems, communication links, or some other type of communication equipment—including combinations thereof. Furthermore, communication network 103 may be a collection of networks capable of providing the plurality of notification modes discussed above.

End devices 104-105 each comprise wireless/wired communication circuitry and processing circuitry. End devices 104-105 may also include a user interface, memory device, software, processing circuitry, or some other communication components. End devices 104-105 may each be a telephone, computer, e-book, mobile Internet appliance, network connected television, wireless network interface card, wired network interface card, media player, game console, or some other communication apparatus—including combinations thereof.

Communication links 111-114 use metal, glass, air, space, or some other material as the transport media. Communication links 111-114 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication links 111-114 could be direct links or may include intermediate networks, systems, or devices.

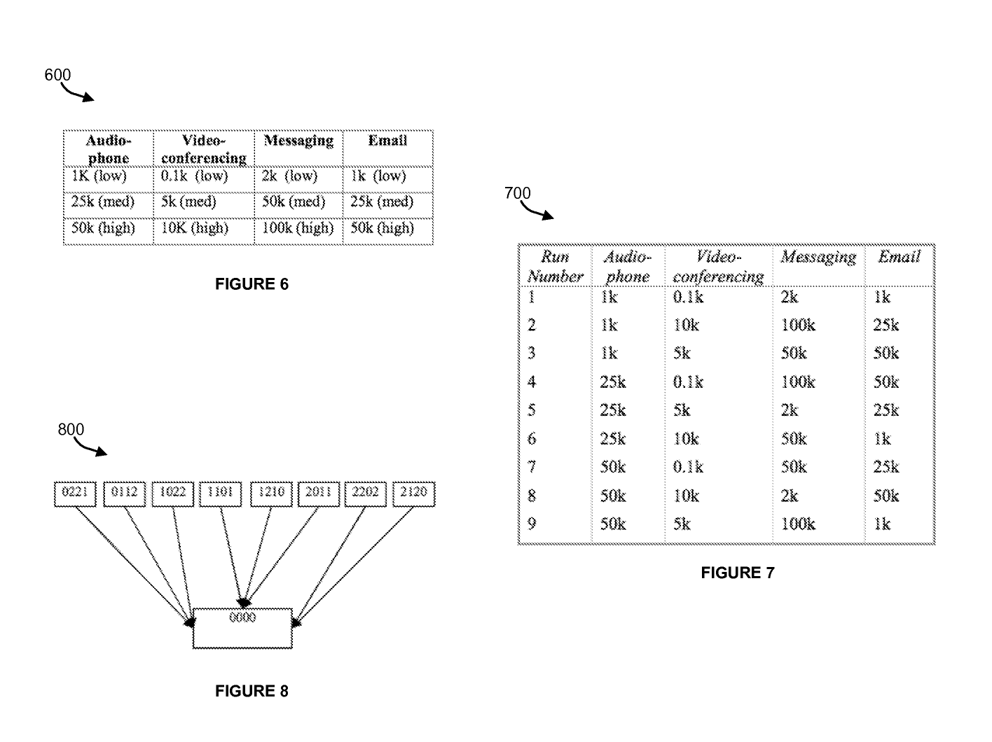

FIG. 6 illustrates an exemplary 4-factor combinatory system 600 to evaluate performance stress in a multi-modal network notification service. 4-factor combinatory system 600 includes 4 modes: audio phone, videoconferencing, messaging, and email. Each mode is assigned three testing levels corresponding to a low notification load, a medium notification load, and a high notification load. An operator of test system 101 may enter the parameters for 4-factor combinatory system 600 into test system 101, test system 101 may generate the factors itself, or test system 101 may receive the factors by other means.

FIG. 7 illustrates pairwise covering array 700 that is generated by test system 101 from the 4-factor combinatory system 600. Pairwise covering array is a minimal covering array that includes 9 test runs. The 9 test runs cover each possible combination between pairs of modes. In other words, a level for a particular mode is paired against each level of every other node once in the 9 test runs. For simplicity, the low, medium, and high levels for each mode will be represented with 0, 1, and 2, respectively, as the example continues below.

FIG. 8 illustrates escalation hierarchy 800 of covering array 700. Escalation hierarchy 800 includes two hierarchy levels with the root having test factors 0000 from test run 1 in covering array 700. The test factors from runs 2-9 then branch directly from the root as performance escalations of 0000. The test factors from test runs 2-9 are all performance escalations of test run 1 because the each test factor in the test runs 2-9 is equal to or higher than the corresponding test factor in test run 1. In an example of what would not be a performance escalation, 1010 is not an escalation of 0110 because, while the first factor level increases, the second factor decreases.

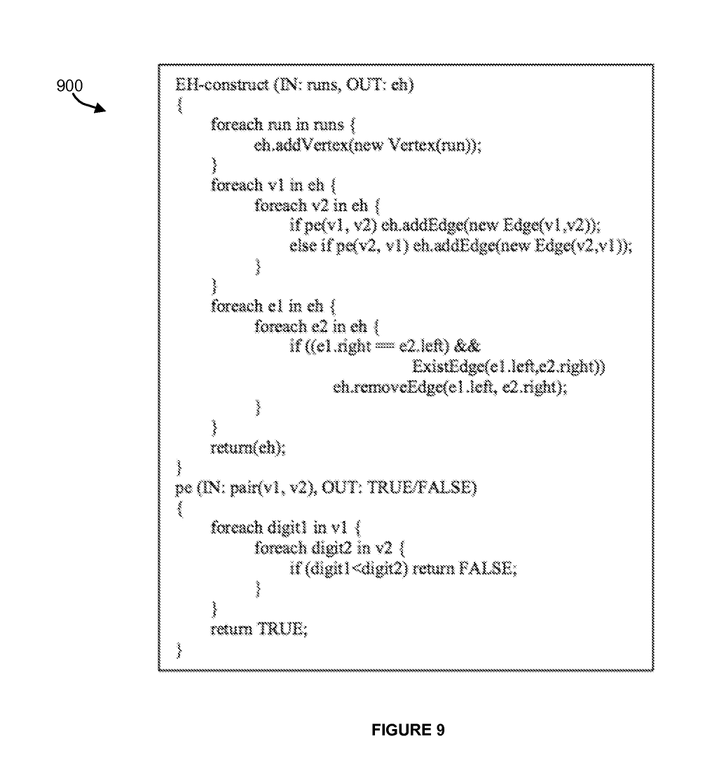

FIG. 9 provides pseudo-code 900 for generating escalation hierarchies. Any programming language known in the art that can be compiled for use in test system 101 may be used to implement the algorithm of pseudo-code 900. Escalation hierarchy 800 is one of many escalation hierarchies that can be generated from covering array 700 but may not be the best escalation hierarchy for determining data inconsistency. Escalation hierarchy 800 has only two hierarchal levels and more hierarchal levels are more effective for detecting data inconsistencies in notification test runs. Therefore, the algorithm pseudo-code 900 may be used by test system 101 to generate more escalation hierarchies that include more hierarchal levels than the two of escalation hierarchy 800.

The algorithm of pseudo-code 900 creates a graph with a node (vertex) representing the factors in each experimental run. Then directed edges between nodes are created to represent an escalation relation between a pair of nodes by determining whether one node is a performance escalation of the other. The algorithm then removes directed edges so that each escalation is only represented one in the graph. For example, if node if A is an escalator of nodes B and C, while node B is an escalator of node C, then the edge from A to C can be removed because the link from A to B and B to C would automatically imply the link from A to C.

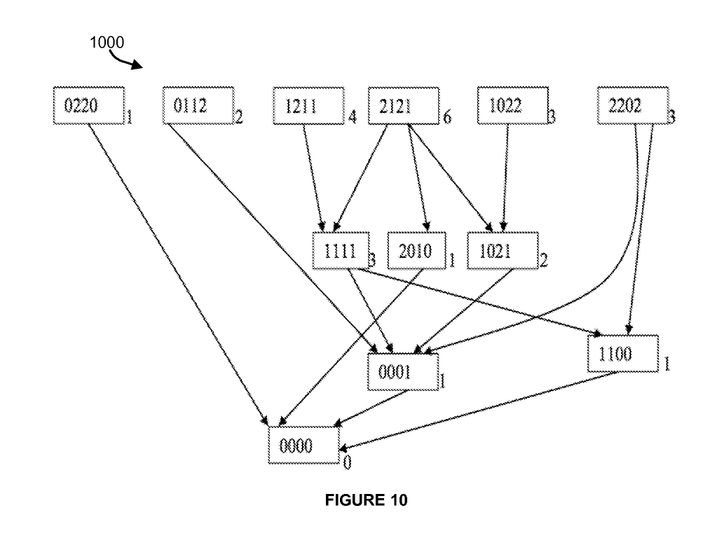

FIG. 10 illustrates escalation hierarchy 1000, which may be generated from covering array 700 using pseudo-code 900. Escalation hierarchy 1000 includes four hierarchal levels compared with the two hierarchal levels of escalation hierarchy 800. Other escalation hierarchies may further be generated by test system 101 using the algorithm of pseudo-code 900.

After the generation of the escalation hierarchies, the degree of escalation of a hierarchy design may be determined to select an escalation hierarchy that can best be used to check data consistency for further capacity evaluation. An escalation hierarchy can be defined as a graph of (N, E) where N is a set of nodes (total number of runs) and E a set of directed edges. An edge from node x to y means x is a direct escalator of y. “Direct escalator of x from y” means there is not any node i such that node x is an escalator of node i and node i is an escalator of node y in the graph. There may be some potential experimental runs in between direct escalation pairs, but those runs are not explicitly included in the graph. For example, the direct escalation from 0000 to 2120 in escalation hierarchy 800 has many potential runs in between them, an example of which is 2100. 2100 is a potential run, but not an actual run included in escalation hierarchy 800.

The degree of escalation is the percentage of possible escalation included in a set of design. For example, escalation hierarchy 800 has only two layers with 8 escalations. The complete situation would have an escalation number of 2 out of n (vertex number), i.e. n(n−1)/2, total possible escalations among all n nodes in an escalation hierarchy. In this case, n is 9 and the total number of possible edges are 9*8/2=36. Thus, the degree of escalation in this case is 8/36=22%. This degree of escalation can be used to compare escalation hierarchy sets to select escalation hierarchies that are most likely to reveal data inconsistency issues. The more runs a covering array has, the escalation hierarchy needs to have more escalations to achieve a better escalation degree. Accordingly, an escalation hierarchy with the highest degree of escalation may be chosen by test system 101 for performing test data analysis.

Escalation hierarchy 1000 has 12 nodes and the total possible edge number for escalation hierarchy 1000 is 12*11/2=66. To calculate the number of escalations implied in escalation hierarchy 1000, the escalation degree calculation algorithm first marks the number of nodes being escalated from each node, and then sums all the numbers to be the total number of the escalations in the escalation hierarchy. The escalation degree is then calculated as the percentage value of the escalation number over the total possible edge number, Node 0220 has one escalatee 0000, node 0112 has two escalatees 0001 and 0000, node 1211 has 4 escalatees of 1111, 0001, 1100, and 0000, and so on. The number of escalatees of each node is marked on escalation hierarchy 1000 next to the label of each node. The summation of all escalatees gives us the total number of escalations in the diagram as (1+2+4+6+3+3+3+1+2+1+1+0)=27. So the degree of escalation for escalation hierarchy 1000 is 27/66=41%. Therefore, escalation hierarchy 1000 has 41% of escalations that can be used to check for data consistency.

Once the notification tests have been run on notification system 102 and data has been collected by test system 101 using the test runs in covering array 700, a data consistency check can be performed using an escalation hierarchy selected from the escalation hierarchies generated by pseudo-code 800. A data consistency check is carried out by traversing the escalation hierarchy, starting from the bottom layer, to compare response time of escalators and their lower nodes. Most optimal covering designs have one node at the bottom layer as a root. In the case of more than one node at the bottom layer, the traversing should start from every root and through all directed edges of the entire graph. Since an escalation hierarchy is an acyclic directional graph, the traversal always terminates at the highest layer of the escalation hierarchy.

During the traversal, the response-time values collected by test system 101 for the notification test runs are checked by test system 101 to ensure that every higher level node value is larger than its direct lower-level node values. If the values are not higher, a conflict is detected on the node and the escalation hierarchy method determines that the data set under study is not consistent enough for further analysis. As an example, if 1101 of escalation hierarchy 800 has a lower capacity load-response time than 0000, then a conflict is detected on node 1101 and the data set is determined to be inconsistent for further analysis. The data set is inconsistent because any node conflict is an indication of errors in the data set, which may be caused by their collection process, and any further analysis, or modeling would be meaningless when based on erroneous data. In contrast, if the data set passes the consistency check, test system 101 may identify performance stress points and a set of causing factors for those stress points.

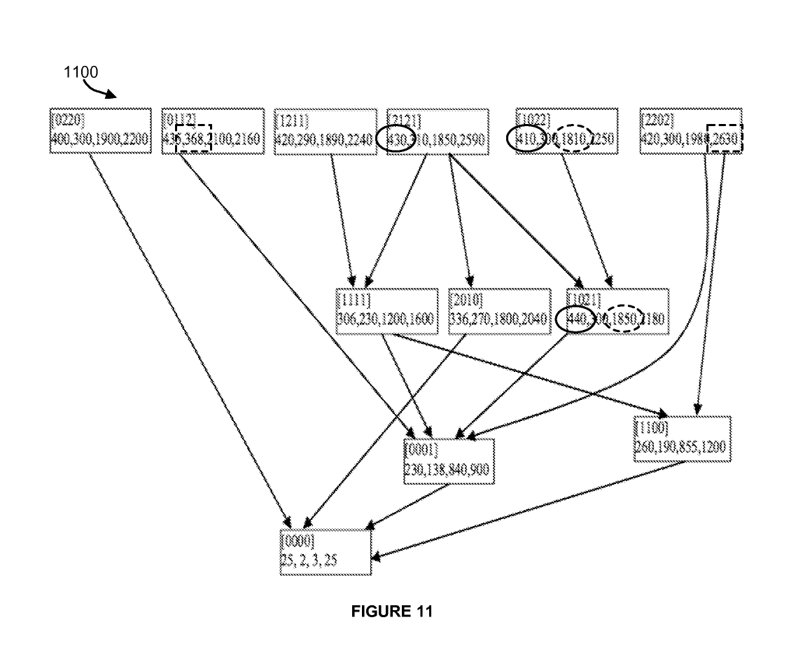

FIG. 11 illustrates escalation hierarchy 1100, which includes response time results for the test run of each node. Escalation hierarchy 1100 includes two dashed ovals around response time values that indicate data inconsistency. In particular, the node at the lower escalation level has a response time value of 1850 for the third test factor while the node at the higher escalation level has a response time value of 1810. Since the node at the higher level should have a response time value greater than or equal to the value at the lower node, the values within the dashed ovals represent inconsistent data. Similarly, the values within the solid ovals in escalation hierarchy 1100 also indicate inconsistent data due to the response time values of the first factor in each test run being higher than that of a lower level node. Therefore, at least the circled data sets in escalation hierarchy 1100 are not used for further analysis.

Furthermore, escalation hierarchy 1100 includes dashed boxes around response time values that have been determined to exceed a threshold value for a corresponding test factor. Therefore, the two boxed values correspond to points of performance stress in the notification system.

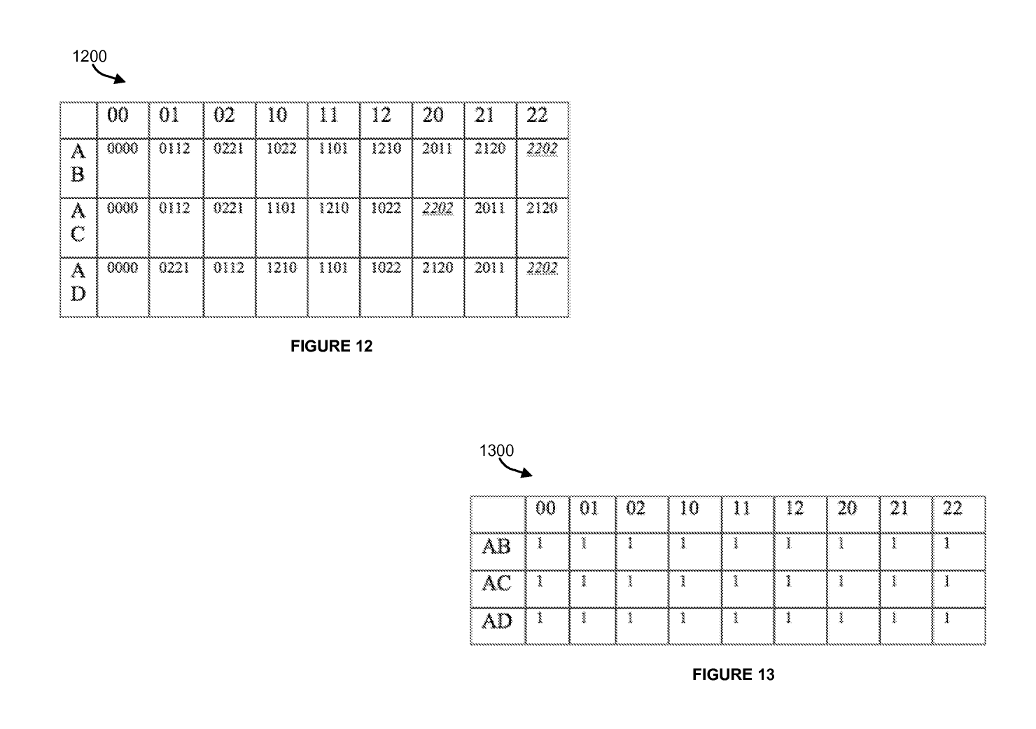

FIG. 12 illustrates a partial exemplary factor-level-run table 1200 after inconsistency and performance stress are detected. The rows of factor-level-run table 1200 display 3 of the possible mode pairs between audio phone (A), videoconferencing (B), messaging (C), and email (D). The columns represent the possible level combinations for each of the mode pairs. The cells of factor-level-run table 1200 correspond to test runs that include the mode and level combination of the row and column for each cell. For example, the cell for row AC and column 02 displays that the test run 0221 included level 0 for A and 2 for C. While factor-level-run table 1200 contains only one run per cell, in some embodiments, additional runs may satisfy the requirements of a cell and, therefore, also be included in the cell.

After generating factor-level-run table 1200, test system 101 is able to display on factor-level-run table 1200 the test runs that resulted in performance stress on notification system 102. Specifically, the underlined test runs in factor-level-run table 1200 indicate test runs that resulted in performance stress. In this example, test run 2202 resulted in performance stress.

Based on test run 2202 resulting in performance stress, the possible pair-wise causes of performance stress point would be AB=22, AC=20 and AD=22 because all runs in the cells of row AB column 22, row AC column 20, and row AD column 22 are failed tests. With this information, the capacity limitation of the notification system/service under study can be determined along with causing factors.

In fact, a complete factor-level-run table of which factor-level-run table 1200 is a portion gives us a list of multiple pair-wise causing factors for 2202 being a performance stress point: A=2, B=2, C=0, D=2, AB=22, AC=20, AD=22, BC=20, BD=22 or CD=02. To pinpoint the exact causing factors or to narrow down the list of candidates, the factors that have been verified by other test runs to not be causing factors are eliminated as candidates. More new test runs are then added to the escalation hierarchy for higher hierarchy levels and further inconsistency detection. For example the four factors A=2, B=2, C=0, and D=2 have all appeared in other successful tests and cannot individually be the causing factors. All the other 6 pairs are not in any other tests, i.e. there are no other successful test runs in those 6 cells, and thus those 6 pairs are all potential causing factor pairs of 2202 being a stress point.

An incremental approach is used to generate more tests to pinpoint the performance stress causing factors. An ongoing follow-up to this incremental test generation is the modeling and prediction of performance as related to the input load. When the number of test runs is sufficient, i.e. enough samples are collected, a model relating loads and performance can be created and used to predict future notification traffic loads and their potential performance.

The algorithm to populate the factor-level-run table is linear to the size of the test run. For each test run of an array of numerical values, iterate through each row of the table to find the corresponding values of each combination and fill in the test run to the appropriate cell. Considering test run 2202 as an example, for the row AB, the test run has the value of 22, so 2202 is added to the cell of row AB and column 22. For the row AC, it has the value of 20, so similarly add 2202 to the cell of row AC and column 20. Repeat this procedure for all rows on all test runs and a factor-level-run table will be populated with all design runs.

FIG. 13 illustrates a partial exemplary factor-level-run table 1300. While factor-level-run table 1300 is similar to factor-level-run table 1100, the cells of factor-level-run table 1300 indicate a number of runs rather than the test factors of the runs themselves. Factor-level-run table 1300 may be used to check the balance of the test runs. A complete version of factor-level-run table 1300 includes all possible factors, their combinations, and possible values. A balanced design would have similar number of test runs in each cell of the table. Therefore, the number of runs on each cell of factor-level-run table 1300 indicates the distribution of test runs in the input space, either balanced or un-balanced.

All cells of factor-level-run table 1300 have the same value. For a covering array, all values of a factor-level-run table cell should be larger than or equal to 1, i.e. each cell should be filled with at least one test run. For a balanced covering array, each cell should be covered similar times, i.e. the size of each cell should be about the same for an FLR table.

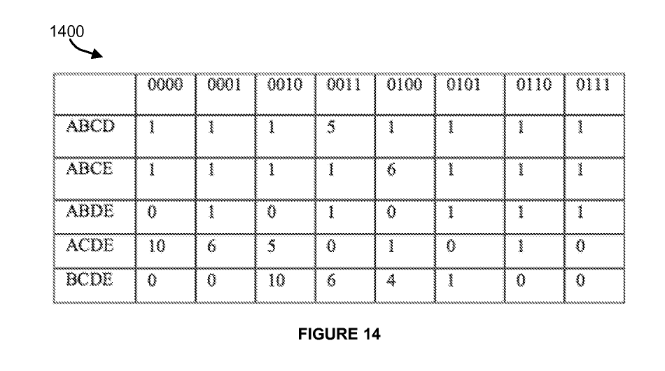

FIG. 14 illustrates a factor-level-run table 1400, which provides an example of a partial 4-way combinatorial factor-level-run table. The example in factor-level-run table 1400 is not a full 4-way covering design. The design is also not balanced. In this case, the 4-way coverage of the design can be calculated as the number of cells with values larger or equal to 1 over the total number of cells. Assuming factor-level-run table 1400 is a full table of a design, then its 4-way coverage percentage is 30/40=75%, where 30 is the number of non-zero cells and 40 is the total number of cells in factor-level-run table 1400.

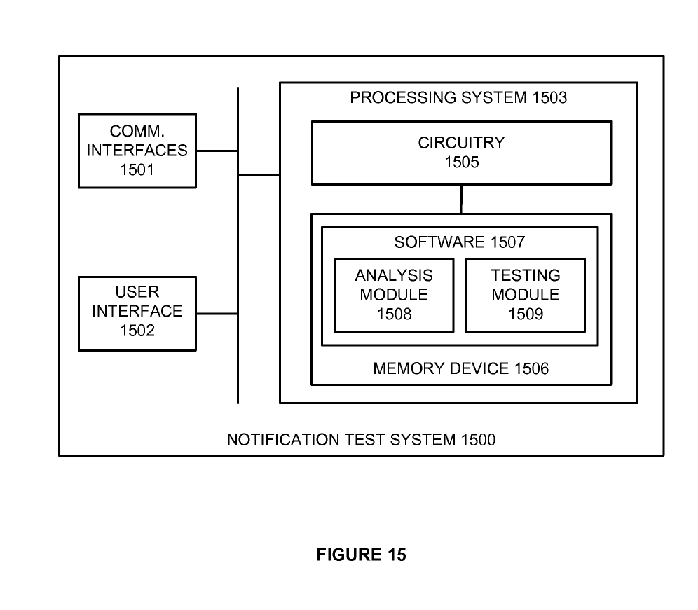

FIG. 15 illustrates notification test system 1500. Notification test system 1500 is an example of notification test system 103, although control system 103 may use alternative configurations. Notification test system 1500 comprises communication interface 1501, user interface 1502, and processing system 1503. Processing system 1503 is linked to communication interface 1501 and user interface 1502. Processing system 1503 includes processing circuitry 1505 and memory device 1506 that stores operating software 1507.

Communication interface 1501 comprises components that communicate over communication links, such as network cards, ports, RF transceivers, processing circuitry and software, or some other communication devices. Communication interface 1501 may be configured to communicate over metallic, wireless, or optical links. Communication interface 1501 may be configured to use TDM, IP, Ethernet, optical networking, wireless protocols, communication signaling, or some other communication format—including combinations thereof.

User interface 1502 comprises components that interact with a user. User interface 1502 may include a keyboard, display screen, mouse, touch pad, or some other user input/output apparatus. User interface 1502 may be omitted in some examples.

Processing circuitry 1505 comprises microprocessor and other circuitry that retrieves and executes operating software 1507 from memory device 1506. Memory device 1506 comprises a non-transitory storage medium, such as a disk drive, flash drive, data storage circuitry, or some other memory apparatus. Operating software 1507 comprises computer programs, firmware, or some other form of machine-readable processing instructions. Operating software 1507 includes analysis module 1508 and testing module 1509. Operating software 1507 may further include an operating system, utilities, drivers, network interfaces, applications, or some other type of software. When executed by circuitry 1505, operating software 1507 directs processing system 1503 to operate notification test system 1500 as described herein.

In particular, analysis module 1508 directs processing system 1503 to generate a covering array of test factors corresponding to a plurality of modes and a plurality of test level values for each mode and determine an escalation hierarchy of the covering array comprising a plurality of nodes, wherein each node corresponds to a set of test factors in the covering array. Testing module 1509 directs processing system 1503 to perform a notification test run of the set of test factors for each node in the escalation hierarchy to determine performance stress for each set of test factors. Analysis module 1508 further directs processing system 1503 to generate a first factor-level-run table with the notification test runs corresponding to each of n-wise test factors and possible test level values and indicate which of the notification test runs in the factor-level-run table resulted in performance stress.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a notification test system, comprising:
generating a covering array of test factors corresponding to a plurality of modes and a plurality of test level values for each node;
determining an escalation hierarchy of the covering array comprising a plurality of nodes, wherein each node corresponds to a set of test factors in the covering array;
performing a notification test run of the set of test factors for each node in the escalation hierarchy to determine performance stress for each set of test factors;
generating a first factor-level-run table with the notification test runs corresponding to each of n-wise test factors and possible test level values; and
indicating which of the notification test runs in the factor-level-run table resulted in performance stress.

2. The method of claim 1, further comprising:
generating a second factor-level-run table with a number of notification test runs corresponding to each of the n-wise test factors and possible test level values.

3. The method of claim 1, wherein determining the escalation hierarchy comprises:
generating a plurality of escalation hierarchies of the covering array each comprising a plurality of nodes;
selecting the escalation hierarchy from the plurality of escalation hierarchies based on a degree of escalation for each escalation hierarchy, wherein the degree of escalation comprises a percentage of possible escalation for each escalation hierarchy.

4. The method of claim 3, wherein selecting the escalation hierarchy from the plurality of escalation hierarchies based on the degree of escalation for each escalation hierarchy comprises:
selecting the escalation hierarchy from the plurality of escalation hierarchies that has the highest degree of escalation.

5. The method of claim 1, further comprising:
determining a response time value for each node in the escalation hierarchy during the notification test runs;
if a response-time value for a higher node is less than a response-time value for a lower node, indicating that the escalation hierarchy is inconsistent for further analysis.

6. The method of claim 1, wherein the performance stress is caused by a notification capacity overload.

7. The method of claim 1, wherein the plurality of modes comprises at least two of audio phone, video conferencing, instant messaging, email, and text messaging.

8. The method of claim 1, further comprising:
analyzing the factor-level-run table to determine which of the test factors caused the performance stress.

9. The method of claim 8, wherein analyzing the factor-level-run table comprises:
eliminating test factors that have been verified by other test runs as not being test factors that caused the performance stress.

10. A non-transitory computer readable medium having instructions stored thereon for operating a notification test system, wherein the instructions, when executed by the notification test system, direct the notification test system to:
generate a covering array of test factors corresponding to a plurality of modes and a plurality of test level values for each node;
determine an escalation hierarchy of the covering array comprising a plurality of nodes, wherein each node corresponds to a set of test factors in the covering array;
perform a notification test run of the set of test factors for each node in the escalation hierarchy to determine performance stress for each set of test factors;
generate a first factor-level-run table with the notification test runs corresponding to each of n-wise test factors and possible test level values; and
indicate which of the notification test runs in the factor-level-run table resulted in performance stress.

11. The non-transitory computer readable medium of claim 10, wherein the instructions further direct the notification test system to:
generate a second factor-level-run table with a number of notification test runs corresponding to each of the n-wise test factors and possible test level values.

12. The non-transitory computer readable medium of claim 10, wherein the instructions direct the notification test system to determine the escalation hierarchy by:
generating a plurality of escalation hierarchies of the covering array each comprising a plurality of nodes;
selecting the escalation hierarchy from the plurality of escalation hierarchies based on a degree of escalation for each escalation hierarchy, wherein the degree of escalation comprises a percentage of possible escalation for each escalation hierarchy.

13. The non-transitory computer readable medium of claim 12, wherein the instructions direct the notification test system to select the escalation hierarchy from the plurality of escalation hierarchies based on the degree of escalation for each escalation hierarchy by:
selecting the escalation hierarchy from the plurality of escalation hierarchies that has the highest degree of escalation.

14. The non-transitory computer readable medium of claim 10, wherein the instructions further direct the notification test system to:
determine a response time value for each node in the escalation hierarchy during the notification test runs;
if a response-time value for a higher node is less than a response-time value for a lower node, indicate that the escalation hierarchy is inconsistent for further analysis.

15. The non-transitory computer readable medium of claim 10, wherein the performance stress is caused by a notification capacity overload.

16. The non-transitory computer readable medium of claim 10, wherein the plurality of modes comprises at least two of audio phone, video conferencing, instant messaging, email, and text messaging.

17. The non-transitory computer readable medium of claim 10, wherein the instructions further direct the notification test system to:
analyze the factor-level-run table to determine which of the test factors caused the performance stress.

18. The non-transitory computer readable medium of claim 17, wherein the instructions further direct the notification test system to analyze the factor-level-run table by:
eliminating test factors that have been verified by other test runs as not being test factors that caused the performance stress.

19. A notification test system, comprising:
processing circuitry configured to:
generate a covering array of test factors corresponding to a plurality of modes and a plurality of test level values for each node;
determine an escalation hierarchy of the covering array comprising a plurality of nodes, wherein each node corresponds to a set of test factors in the covering array;
perform a notification test run of the set of test factors for each node in the escalation hierarchy to determine performance stress for each set of test factors;
generate a first factor-level-run table with the notification test runs corresponding to each of n-wise test factors and possible test level values; and
indicate which of the notification test runs in the factor-level-run table resulted in performance stress.

20. The notification test system of claim 19, wherein the processing circuitry is further configured to:
generate a second factor-level-run table with a number of notification test runs corresponding to each of the n-wise test factors and possible test level values.
